(19) United States
(12) Patent Application Publication
(10) Pub. No.: US 2011/0172954 A1
(43) Pub. Date: Jul. 14, 2011

(54) FENCE INTRUSION DETECTION

(75) Inventors: Theodore W. Berger, Rancho Palos Verdes, CA (US); Alireza Dibazar, Los Angeles, CA (US); Ali Yousefi, Los Angeles, CA (US)

(73) Assignee: UNIVERSITY OF SOUTHERN CALIFORNIA, Los Angeles, CA (US)

(21) Appl. No.: 12/763,974

(22) Filed: Apr. 20, 2010

Related U.S. Application Data
(60) Provisional application No. 61/170,963, filed on Apr. 20, 2009.

(51) Int. Cl. G06F 15/00

(52) U.S. Cl. 702/150

(57) ABSTRACT

A compact, inexpensive, and reliable fence intrusion detection system may detect activity on a fence and determine the type of activity based on discrimination. The hardware may include a 3-axis accelerometer and a RISC microprocessor. The system may be equipped with a wireless device which enables the system to work remotely and communicate with a base station. An algorithm may detect activity vs. no-activity on the fence. The algorithm may thereafter recognize the type of the activity; such as whether it is due to rattling caused by strong wind or a breach such as a person climbing the fence. The recognition algorithm may be computationally inexpensive and therefore also may be embedded inside a local RISC microcontroller. The system has been tested on different fences and demonstrated an over 90% correct recognition rate.

### CROSS-REFERENCE TO RELATED APPLICATIONS

This application is based upon and claims priority to U.S. Provisional Patent Application No. 61/170,963, entitled “INTELLIGENT FENCE INTRUSION DETECTION SYSTEM: DETECTION OF INTENTIONAL FENCE BREACHING AND RECOGNITION OF FENCE CLIMBING,” filed Apr. 20, 2009, attorney docket number 028080-0468. The entire content of this application is incorporated herein by reference.

This application is related to U.S. Provisional Application Ser. No. 60/977,273, filed Oct. 3, 2007, entitled, “Security Breach Detection and Localization Using Vibration Sensors,” Attorney Docket No. 028080-0292; U.S. patent application Ser. No. 12/244,549, filed Oct. 2, 2008, entitled “Systems and Methods for Security Breach Detection,” Attorney Docket No. 028080-0370; U.S. Provisional Application Ser. No. 61/167,822, filed Apr. 8, 2009, entitled “Cadence Analysis of Temporal Gait Patterns for Seismic Discrimination Between Human and Quadruped Footsteps,” Attorney Docket No. 028080-0457; and U.S. Provisional Application Ser. No. 61/169,565, filed Apr. 15, 2009, entitled “Protecting Military Perimeters from Approaching Human and Vehicle Using Biologically Realistic Dynamic Synapse Neural Network.” The entire content of all of these applications is incorporated herein by reference.

### STATEMENT REGARDING FEDERALLY SPONSORED RESEARCH

This invention has been made with government support under Office of Naval Research (ONR) Grant No. N00014-06-1-0117 and Office of Naval Research (ONR) Grant No. N00014-07-1-0132, awarded by the United States Government. The government has certain rights in the invention.

### BACKGROUND

1. Technical Field

This disclosure relates to fence intrusion systems.

2. Description of Related Art

Fences may be used to isolate and protect public and private places against unauthorized access, such as airports, military bases, power stations, and construction zones. However, fences alone may not be sufficient to prevent intrusion.

Sensors may be used to capture fence activity, including accelerometers, cameras, geophone sensors, microphones, optical fiber sensors, capacitive sensors, infra-red sensors, and magnetic sensors. Systems build around these sensors may detect fence intrusions.

However, each type of system may have drawbacks. Accelerometers, for example, may detect fence vibration which may be indicative of an intrusion. However, vibration may also be indicative of other activity, such as wind.

Some have suggested classifying intrusions. However, classification approaches may need to be customized for each different type of fence, including fences with different lengths, heights, and sagginess. Some of these classification approaches may also require expensive hardware platforms to meet required computational complexities. For example, one system compares the signal level of sensor output with an adaptive threshold to detect an event on the fence. See Dr. Mel C. Maki; Jeremy K. Weese; IntelliFiber, Fiber Optic Sensor Developments, IEEE 37^{th} Annual International Carnahan Conference on Security Technology, 14-16 Oct. 2003. The threshold level of this system may need to be continuously updated using background noises or environmental variations to keep the sensitivity of the system constant. This system may also not be capable of discriminating between horizontal movement (e.g., rattling) and vertical movement (e.g., climbing).

An acoustic-based system has been proposed. See J. de Vries, A low cost fence impact classification system with neural networks, IEEE AFRICON 2004. This system employs a neural network classifier with frequency domain features to detect intrusion (climbing, cutting and jumping) around fences. However, the performance of this system may decay when the quality of the sound (e.g., signal-to-noise ratio) generated by the intruders and surrounding environment decreases. Moreover, in order to locate the suspect, this system may require more than one sensor which may make the system complex and expensive.

Another system uses image processing and analyzes continuous frames of video to detect suspicious activity around the fences. See Geoff Thiel, Automatic CCTV Surveillance—Toward Virtual Guard, IEEE Aerospace and Electronic System Magazine, July 2000. However, this system may require defined background conditions and may fail if anything blocks the view of the camera.

A biologically realistic neural network classifier has been used to detect human or vehicles around the fences. See Dibazar, Alireza A; Park, Hyung O; Berger, Theodore W.; The Application of Dynamic Synapse Neural Networks on Footstep and Vehicle Recognition, IJCNN 2007, 12-17 August, Orlando, Fla. However, this system focuses on vehicle or human detection, rather than fence intrusion.

### SUMMARY

A fence intrusion detection system may include a sensor configured to generate one or more signals indicative of movement of the fence. A signal processing system may be configured to distinguish based on the signals between movement of the fence and substantially no movement of the fence. The signal processing system may be configured to distinguish based on the signals between movement of the fence caused different types of activity, such as rattling of the fence, climbing of the fence, kicking of the fence, leaning on the fence, and/or activity other than rattling, climbing, kicking of and/or leaning on of the fence.

The fence intrusion system may include a rechargeable power source and may be configured to power down a substantial portion of the signal processing system when the one or more signals from the sensor indicate that there is substantially no movement of the fence.

One or more signals from the sensor may be indicative of acceleration of the fence. The signal processing system may be configured to distinguish between movement and substantially no movement of the fence by comparing the magnitude of the acceleration with a threshold. The threshold may be dynamic and the fence intrusion system may be configured to adjust the threshold. The fence intrusion system may be configured to adjust the threshold based on long term changes in the magnitude of the acceleration.

The signal processing system may be configured to distinguish between movement and substantially no movement of the fence based on a time analysis of the one or more signals.

The signal processing system may include a Gausian mixture model configured to detect movement of the fence from the one or more signals and a Gausian mixture model configured to detect substantially no movement of the fence from the one or more signals. The signal processing system may be configured to distinguish between movement and substantially no movement of the fence based on which of the Gausian mixture models provides a higher output.

The signal processing system may include a Gausian mixture model configured to detect movement of the fence cause by rattling of the fence from the one or more signals, a Gausian mixture model configured to detect movement of the fence cause by climbing of the fence from the one or more signals, and/or a Gausian mixture model configured to detect movement of the fence cause by activity other than rattling or climbing of the fence from the one or more signals. The signal processing system may be configured to distinguish between movement of the fence caused by rattling of the fence, by climbing of the fence, and/or by activity other than rattling or climbing of the fence based on which of the Gausian mixture models provides a higher output. Gausian mixture models may also be used to distinguish between rattling, climbing, kicking, leaning, and/o activity other than rattling, climbing, kicking, and/or leaning.

The sensor may be configured to sense movement in three orthogonal directions X, Y, & Z. The signal processing system may be configured to distinguish between movement of the fence caused by rattling of the fence and by climbing of the fence based on the following feature vector:

F=(Sᵥ,E_{X/Z},E_{Y/Z},E_{F1|X},E_{F2|X},E_{F1|Y},E_{F2|Y},E_{F1|Z},E_{F2|Z})

where

### Sᵥ: Signal Variation

E_{x/z}: Relative energy of X axis to Z axis
E_{x/z}: Relative energy of Y axis to Z axis
E_{F1|x}: Normalized energy of F1 frequency band in X axis
E_{F2|x}: Normalized energy of F2 frequency band in X axis
E_{F1|Y}: Normalized energy of F1 frequency band in Y axis
E_{F2|Y}: Normalized energy of F2 frequency band in Y axis
E_{F1|Z}: Normalized energy of F1 frequency band in Z axis
E_{F2|Z}: Normalized energy of F2 frequency band in Z axis

The fence intrusion detection system may include a wireless transmission system configured to wirelessly transmit information about the type of activity which is distinguished by the processing system. The system may include a rechargeable power source. The intrusion detection system may be configured to power down a substantial portion of the signal processing system when the one or more signals from the sensor indicate that there is substantially no movement of the fence.

The fence intrusion detection system may include a compartment housing the sensor and at least one fastener configured to attach the compartment to a wire in the fence. The fastener may have a slot which is wider than the diameter of the wire in the fence.

The fence intrusion detection system may include a plurality of fasteners, each configured to attach the compartment to a wire in the fence, and each having a slot which is wider than the diameter of the wire in the fence.

Each of the fasteners may be configured such that the angular orientation of their slot may rotate with respect to the compartment so as to enable the compartment to be attached to fences having wires which create different mesh patterns.

The compartment may be configured with at least one slot in which at least one fastener is positioned configured to enable the longitudinal separation distance between at least two of the fasteners to be adjusted so as to enable the compartment to be attached to fences having wires with different spacings between them.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings disclose illustrative embodiments. They do not set forth all embodiments. Other embodiments may be used in addition or instead. Details which may be apparent or unnecessary may be omitted to save space or for more effective illustration. Conversely, some embodiments may be practiced without all of the details which are disclosed. When the same numeral appears in different drawings, it refers to the same or like components or steps.

FIG. 1 is a block diagram of a fence intrusion detection system.

FIG. 2 illustrates a fence intrusion detection system mounted on a fence.

FIGS. 3A-3C illustrate the X, Y, & Z outputs of the 3-axis accelerometer 101, respectively, while a fence is being rattled.

FIGS. 4A-4C illustrate the X, Y, & Z outputs of the 3-axis accelerometer 101, respectively, while a fence is being climbed.

FIGS. 5A-5C illustrate the X, Y, & Z outputs of the 3-axis accelerometer 101, respectively, while a fence is being kicked.

FIGS. 6A-6C illustrate the X, Y, & Z outputs of the 3-axis accelerometer 101, respectively, while a fence is being leaned on.

FIG. 7 illustrates a histogram of Sᵥ, for data collected from different fences.

FIG. 8 illustrates an example of response characteristics of a filter bank with two filters.

FIG. 9 is a block diagram of a classifier that may be used.

FIG. 10 illustrates a histogram of features in rattling and climbing.

FIG. 11 is a block diagram of an event classifier.

FIG. 12 illustrates an output of the classifier during rattling.

FIG. 13 illustrates an output of the classifier during climbing.

FIG. 14 illustrates the detection of rattling between climbing events.

FIG. 15 illustrates a fence intrusion detection system mounted on a fence.

FIG. 16 illustrates a side view of a fence intrusion detection system, such as the fence intrusion detection system illustrated in FIG. 15.

FIGS. 17A and 17B illustrate a front and back view, respectively, of the fence intrusion detection system illustrated in FIG. 16.

### DETAILED DESCRIPTION OF ILLUSTRATIVE EMBODIMENTS

Illustrative embodiments are now discussed. Other embodiments may be used in addition or instead. Details which may be apparent or unnecessary may be omitted to save space or for a more effective presentation. Conversely, some embodiments may be practiced without all of the details which are disclosed.

Different activities which disturb a fence may be categorized into different classes, such as lean, rattle, kick, climb and substantially no event. Rattling and climbing may be two main events which may be considered as a subset. Each of these two main events may have different motion signatures. From a security point of view, rattling may be considered a preliminary step to intrusion, while climbing may be an actual intrusion.

A fence intrusion detection system (FIDS) may detect suspicious activity on a fence and discriminate between climbing and rattling on chain-link fences, as well as between additional and/or other types of activity. A compact, computationally inexpensive, and expandable FIDS may be constructed and mounted easily on a fence.

A 3-axis accelerometer may be utilized as a sensor to generate output signals indicative of movement of a fence. Other types of sensors may be used in addition or instead. The output of the accelerometer may be fed into a RISC microprocessor. Other types of signal processing systems may be used in addition or instead.

A Bayesian classifier and a state machine may be used for dynamic classification. The classifier may be trained. Other types of classifiers may be used in addition or instead.

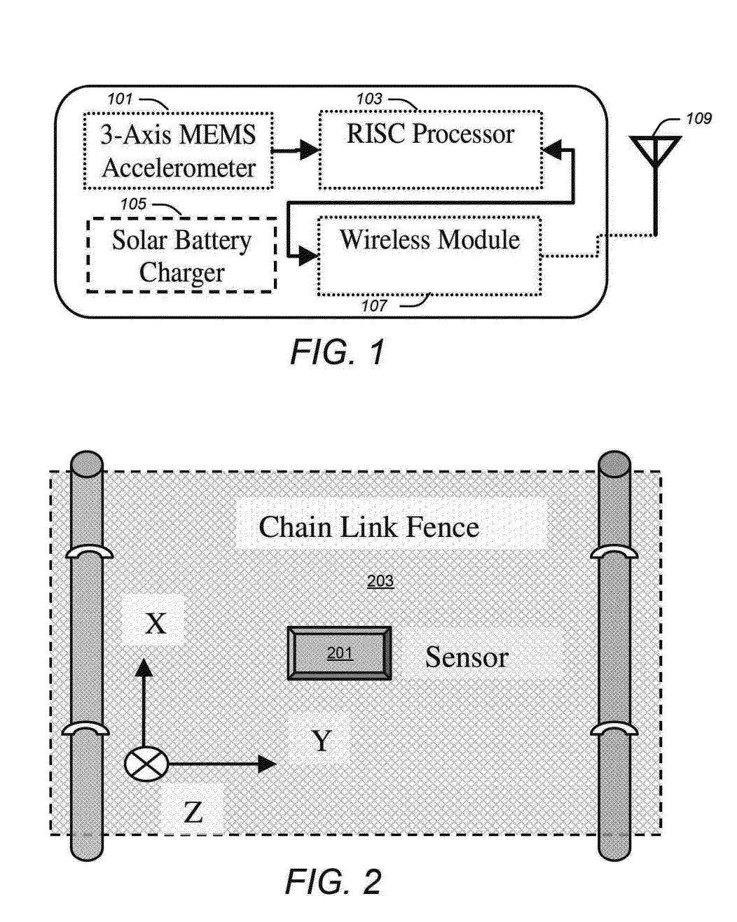

FIG. 1 is a block diagram of a fence intrusion detection system. As illustrated in FIG. 1, the system may include a 3-axis MEMS accelerometer 101 configured to detect movement of a fence, a RISC microprocessor 103 configured to process signals from the 3-axis MEMS accelerometer 101, a rechargeable source of power such as a solar battery charger 105 which may include a rechargeable battery, a wireless module 107 configured to generate a signal for wirelessly transmitting the results of an analysis of the signals from the 3-axis MEMS accelerometer 101 by the RISC processor 103 to a remote location, such as to a central command, and an antenna 109 to wirelessly broadcast the signal.

The accelerometer 101 may be configured to measure fence vibration in three orthogonal directions. Any other type of sensor may be used in addition to or instead. Similarly, any other type of signal processing system may be used in addition or instead of the RISC processor 103.

FIG. 2 illustrates a fence intrusion detection system mounted on a fence. As illustrated in FIG. 2, a fence intrusion detection system 201, such as the system illustrated in FIG. 1, may be mounted on a fence, such as a chain link fence 203. The sensor may be installed anywhere on the fence, such as at or near the center of a fence. The fence 203 may or may not have a bar on the top. Likewise, the bottom of the fence 203 may or may not be buried in the ground.

Several such fence intrusion detection systems may be installed at spaced-apart locations along the perimeter of a fence.

The 3-axis accelerometer 101 may be configured to measure both static and dynamic acceleration along each of three axes. The source of static acceleration may be the earth's gravity. Based on the relative orientation of the sensor to the direction of the earth's gravity, static acceleration may be seen in one, two, or all three sensor axes.

External forces may cause the fence to vibrate, creating dynamic acceleration. When an external force is applied to a fence, the relative angle of the sensor axes and the direction of the force may cause a portion of the acceleration to be projected onto one, two, or three of the sensing axes.

The accelerometer may measure any range of acceleration, such as between −6 to 6 g force in each axis. The accelerometer output may be sampled by an A-to-D converter at different rates, such as by a 10-bit A-to-D at about 360 samples per second per channel.

The fence may be positioned parallel to the direction of earth's gravity. The fence intrusion detection system may be installed on a fence in a way that causes the sensor's X axis to be parallel to the earth's gravity direction.

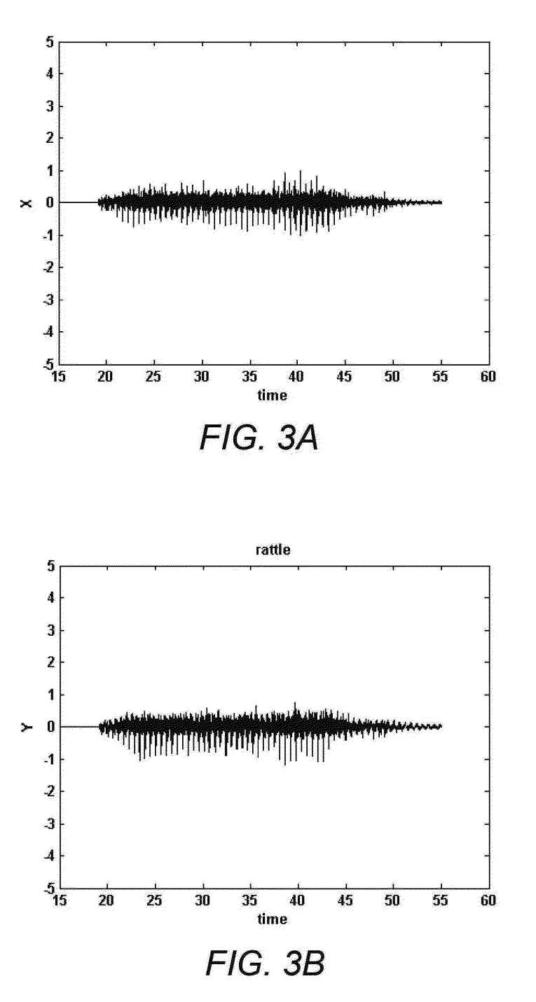

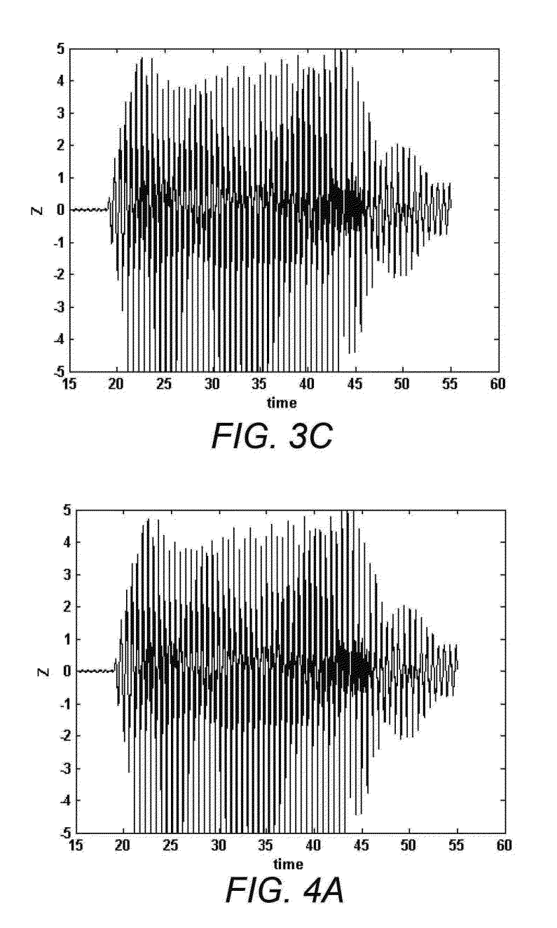

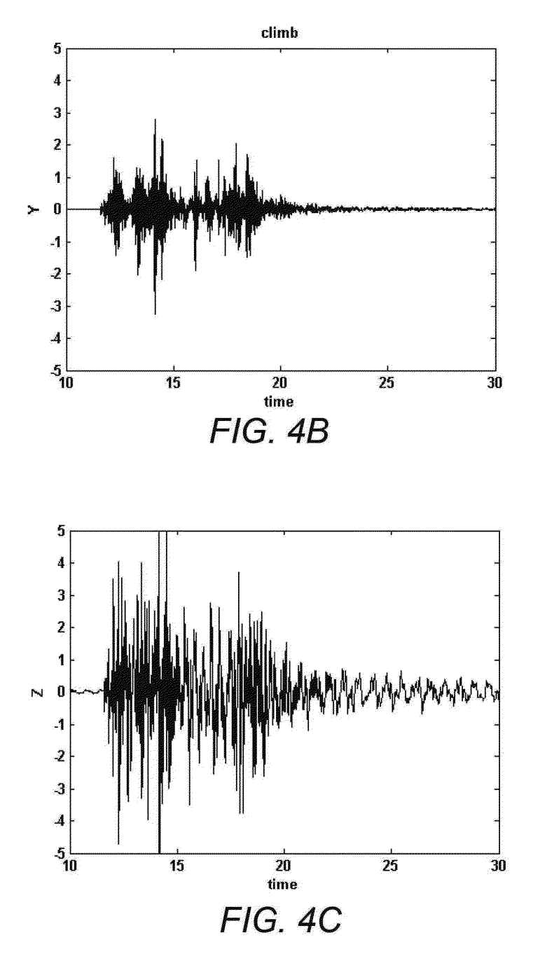

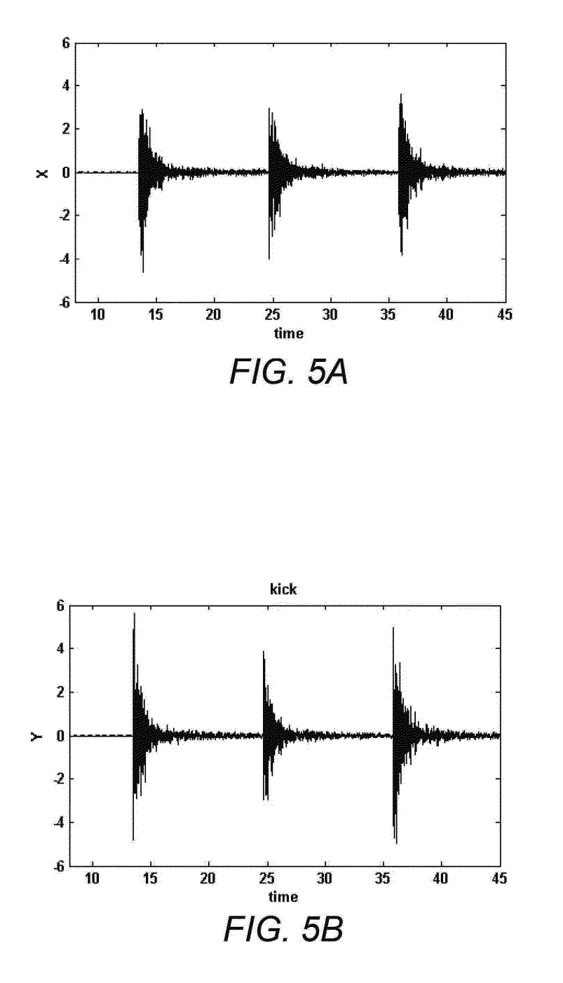

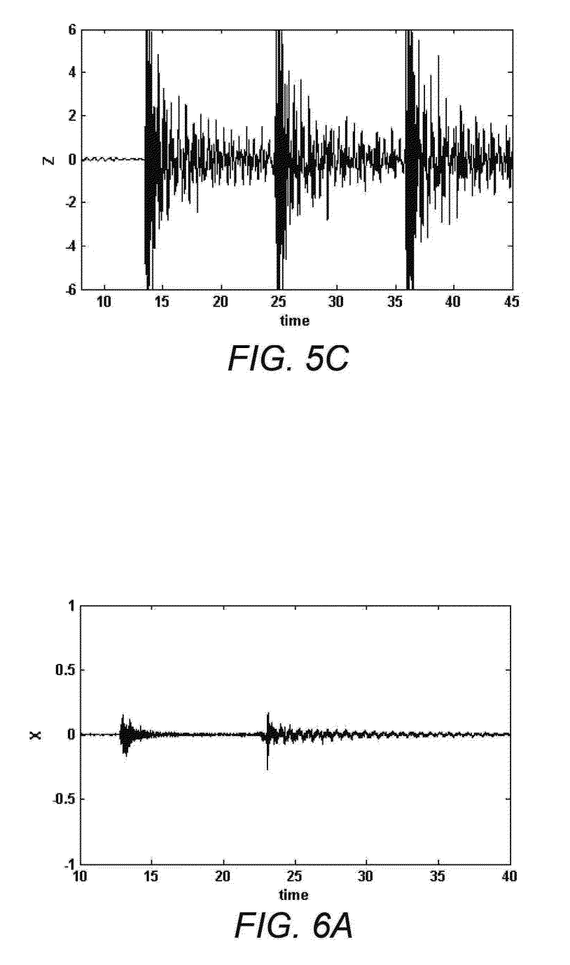

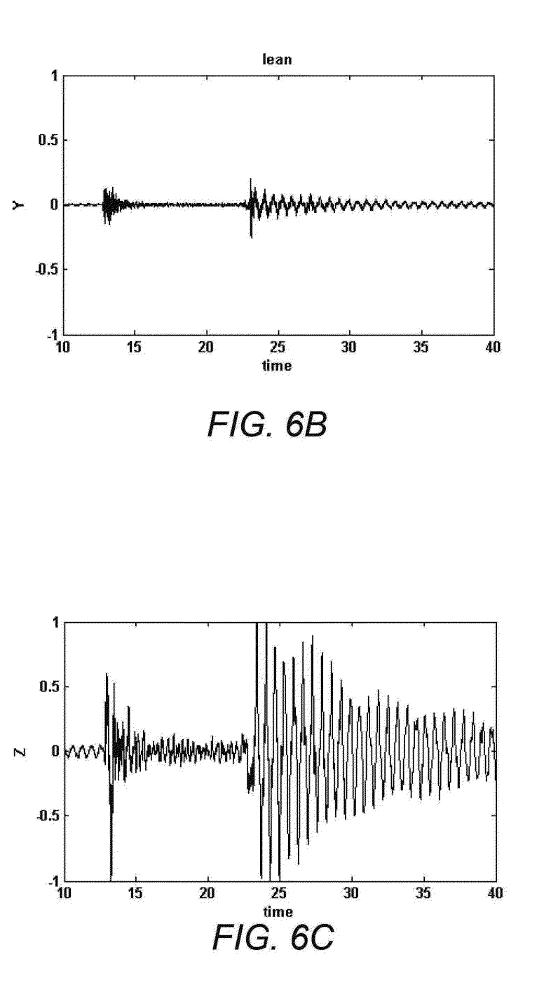

FIGS. 3A-3C illustrate the X, Y, & Z outputs of the 3-axis accelerometer 101, respectively, while a fence is being rattled. FIGS. 4A-4C illustrate the X, Y, & Z outputs of the 3-axis accelerometer 101, respectively, while a fence is being climbed. FIGS. 5A-5C illustrate the X, Y, & Z outputs of the 3-axis accelerometer 101, respectively, while a fence is being kicked. FIGS. 6A-6C illustrate the X, Y, & Z outputs of the 3-axis accelerometer 101, respectively, while a fence is being leaned on.

The RISC processor 103 may be configured to discriminate between various types of fence activity based on the signals received from the accelerometer 101. Any other type of signal processing system may be used in addition or instead.

The RISC processor 103 may be configured to discriminate between fence activity and no fence activity. The RISC processor 103 may be configured to then discriminate within the activity class between rattle and climb classes, between rattle and climb and other activity classes, between rattle and climb and kick classes, between rattle and climb and kick and other activity classes, between rattle and climb and lean classes, between rattle and climb and lean and other activity classes, between rattle and climb and kick and lean classes, and/or between rattle and climb and kick and lean and other activity classes.

There may be a one to one correspondence between force and acceleration (f=m.a). Classification of motion on the fence may directly reflect the type of forces being imposed to the fence. In another words, in order to detect the type of force on the fence (or type of breach), the output signal or signals of the accelerometer may be directly used.

The RISC processor 103 may be configured to find a feature with which presence of an activity on the fence vs. substantially no-activity may be detected. For a statistical/mathematical approach to this issue, it may be assumed that the output signal of the accelerometer 101 is weakly stationary (mean and covariance stationary). This may be a valid assumption when motion near the center of the fence has planar shift (rather than rotation).

There may be no or very little sensor output when the fence has little or no vibration. There may be no dynamic force on the fence, and the signal variance may be very low.

During rattling and climbing, there may be at least one dynamic force component causing fence acceleration, as illustrated in FIGS. 3A-3C and 4A-4C. This may make the variance of the accelerometer signal higher than when there is no such activity on the fence.

In the order to detect an event on the fence, the first feature may be signal variation Sᵥ defined as follows:

$${S}_{v , k} = {\sum }_{i = {k}^{*} N}^{{( k + 1 )}^{*} N - 1} {( {X}_{i} - {m}_{x} )}^{2} + {\sum }_{i = {k}^{*} N}^{{( k + 1 )}^{*} N - 1} {( {Y}_{i} - {m}_{y} )}^{2} + {\sum }_{i = {k}^{*} N}^{{( k + 1 )}^{*} N - 1} {( {Z}_{i} - {m}_{z} )}^{2} \qquad ( 1 )$$

where K is the successive frame number and N defines each frame's sample points.

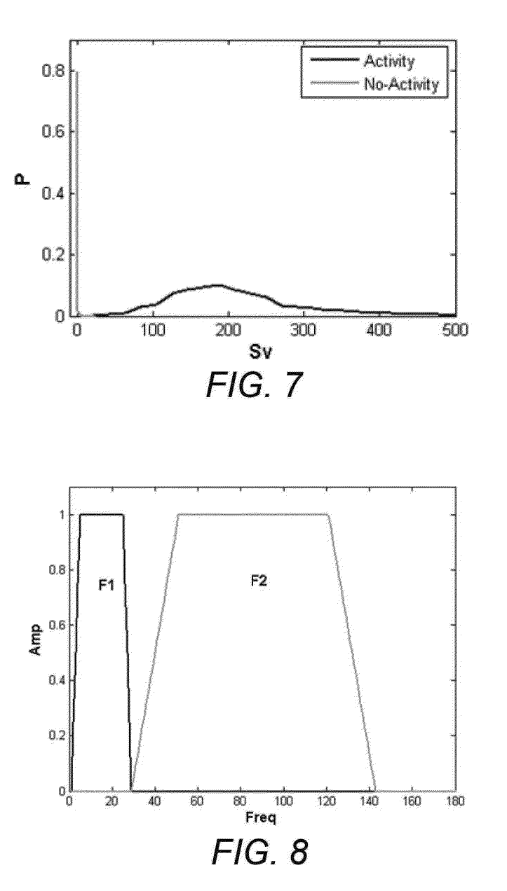

FIG. 7 illustrates a histogram of Sᵥ for data collected from different fences. This figure demonstrates that Sᵥ may be a good feature to discriminate activity vs. substantially no-activity on the fence. A threshold for the classification may be estimated from the plot.

After detecting activity on the fence, the next step may be to divide the activity class into two or more classes of activity, such as into rattling and climbing. Rattle can be defined as periodic fence movement mostly along the Z axis. The periodicity may be determined either by the force periodicity or fence natural resonance frequency.

During a breach, the acceleration in X and Y axes may be smaller than in the Z axis. This property may also be observed in the rattling as shown in FIGS. 3A-3C.

The force pattern in climbing may differ from rattling, as illustrated in FIGS. 4A-4C. When a person climbs on the fence, he/she may exert force upon different points on the fence with different intensities and direction. This may impose non-periodic structure in the sensor output. In addition, there may be a significant level of acceleration in all three axes compared to just one axis for rattling. Unlike rattling, there may be no periodicity in the Z axis when climbing happens.

Therefore, features which consider periodicity of the signal and relative energy of axes may be selected for the classification.

To estimate natural damping frequency of the fence, an elastic plane may be considered. For an elastic plane, the resonance frequencies may be calculated by (nπ/2l), where l is the minimum of (height, width) of the plane and n is a positive integer. Fences may not be elastic and, because of their mass, may get at most the second resonant frequency if they resonate. For a typical 3×2 meter fence, its second resonant frequency may be less than 2 Hz. Therefore, if wind or rain causes fences vibration, the resonant frequency may be less than 2 Hz.

Intentional rattling made by a human may not exceed 10 Hz (its second harmonic may be 20 Hz). Therefore, a filter bank with two filters may be used.

FIG. 8 illustrates an example of response characteristics of a filter bank with two filters. The first filter may have an upper cutoff frequency at about 20 Hz. The second filter may covers the rest of the frequency band. The energy of these two band-pass filters (F1 and F2) may be utilized as features.

In addition to the above-mentioned features, the relative energy of successive frames may also be considered.

The following specific features may be extracted from the accelerometer signals:
Relative energy of X axis to Z axis (E_{x/z})
Relative energy of Y axis to Z axis (E_{Y/z})
Normalized energy of F1 in X axis (E_{F1|x})
Normalized energy of F2 in X axis (E_{F2|x})
Normalized energy of F1 in Y axis (E_{F1|Y})
Normalized energy of F2 in Y axis (E_{F2|Y})
Normalized energy of F1 in Z axis (E_{F1|Z})
Normalized energy of F2 in Z axis (E_{F2|Z})
   where the variables have the same definitions as set forth above.

The sliding window length may be 1.45 seconds with a 50% overlap (512 samples ˜1.45 second). This may be due to having at least one cycle of the signal inside the sliding window.

For each frame of 1.45 seconds, the feature vector may be defined as follows:

F=(Sᵥ,E_{X/Z},E_{Y/Z},E_{F1|X},E_{F2|X},E_{F1|Y},E_{F2|Y},E_{F1|Z},E_{F2|Z}) (2)

The classifiers may be formed based on the feature vector of equation (2), as explained below.

As mentioned earlier, after detecting activity on the fence, the next goal may be to classify the type of activity. Two main class of interest may be rattling and climbing. Other classes of interest may include kicking and leaning. Classifiers may be formed based on features extracted from the output of the accelerometer using Equation 2 above.

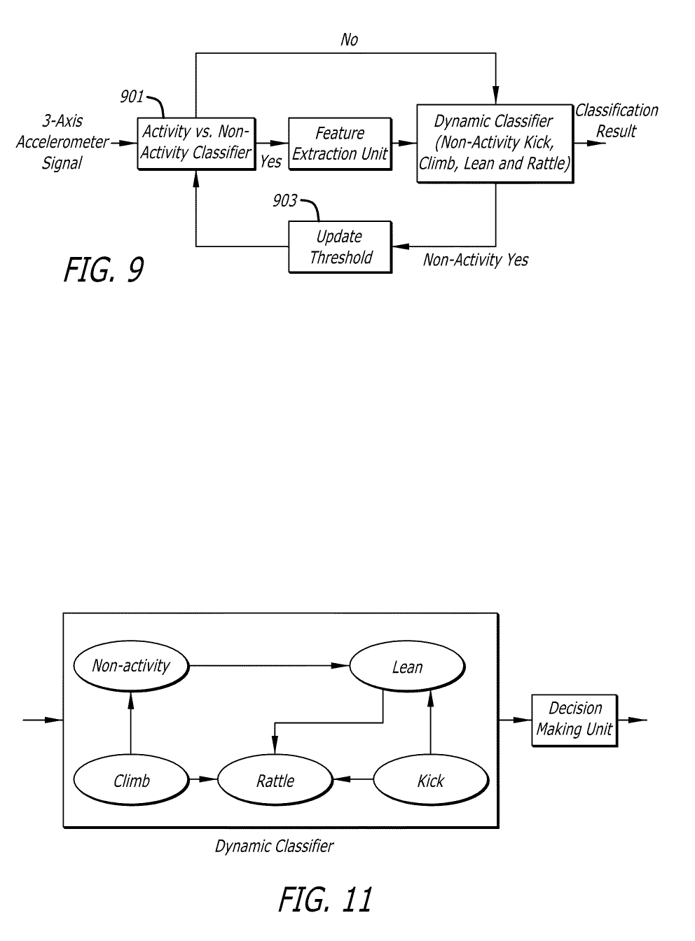

FIG. 9 is a block diagram of a classifier that may be used. An activity classifier 901 may compare the Sᵥ, with an adaptive threshold 903 to decide whether the fence is in an activity or non-activity state. The threshold value in this classifier may be adapted by checking variation of energy of the sensor output (Sᵥ) in previous no activity frames. Using this technique, the classifier sensitivity to wind or rain may be adjusted by information from previous frames. The following equation (3) may provide a recursive adaptation algorithm which may be computationally inexpensive for calculating variation of the signal:

M_{new}=α*M_{old}+(1−α)*Sᵥ

S_{new}=γ*S_{old}+(1−γ)*Sᵥ²

Threshold=M_{new}+k*S_{new} if the frame is no-activity (3)

where M is the mean of Sᵥ, S is the standard deviation of Sᵥ, and (α, γ, k) are constants.

α and γ may be set to 0.1 and k may be 2 in one application. For initializing M and S, mean and variance of the first frame may be used.

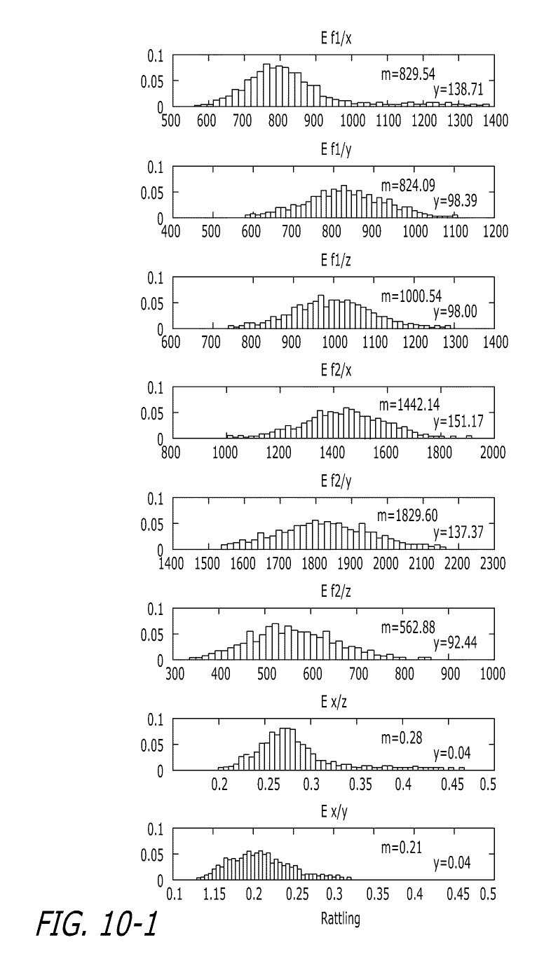

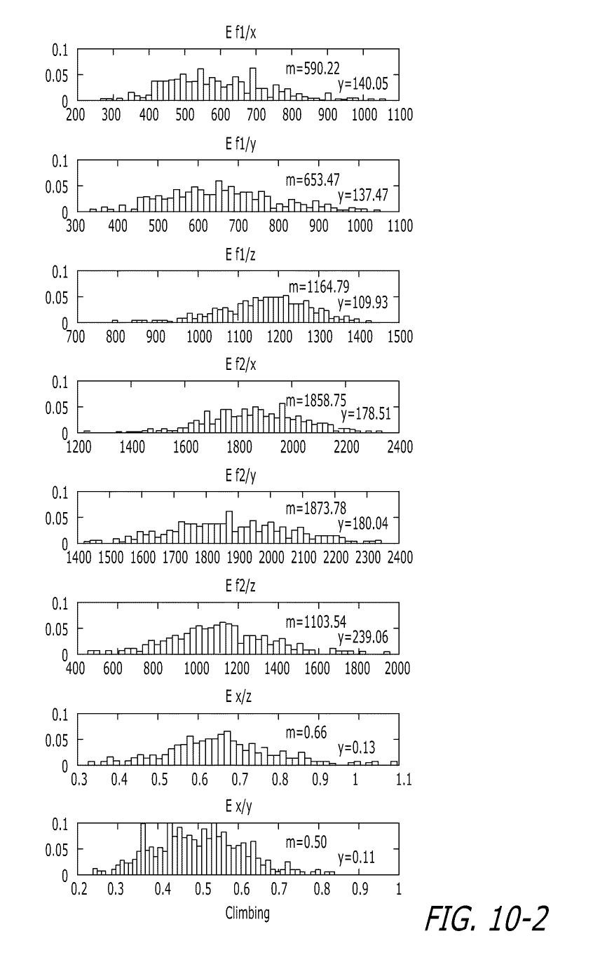

FIG. 10 illustrates a histogram of features in rattling and climbing.

After detecting activity on the fence, features of the signals may be extracted. Distribution of features may look like a Gaussian distribution, as illustrated in FIG. 10, Gaussian Mixture Models (GMM) may be set up to model the feature space. One Gaussian mixture may be employed in this application for each feature. The training of GMMs may be performed using the EM algorithm or by any other means. In order to enhance performance of recognition, one GMM may also be formed to model the no-activity state. This may help to reject false detection of activity on the fence.

Along with the GMM models for three classes of rattling, climbing, and no-activity; a state machine may be utilized. A three-state machine may make final decisions based on the most likely transitions of the last events and the current event. The classifier may check three, five, or a different number of consecutive frames and counts occurrence of different events. The events with more occurrences may be determined as the most likely class.

FIG. 11 is a block diagram of an event classifier. This event classifier decides about the intrusion class by finding the most likely transition between different classes in the last five frames.

The next step may be to define the state transition probabilities between classes. The following 3 by 3 matrix for the transition parameters may be defined:

$$S = [ \begin{matrix}{S}_{na \to na} & {S}_{na \to rt} & {S}_{na \to cl} \\ {S}_{rt \to na} & {S}_{rt \to rt} & {S}_{rt \to cl} \\ {S}_{cl \to na} & {S}_{cl \to rt} & {S}_{cl \to cl}\end{matrix} ] = [ \begin{matrix}0.33 & 0.33 & 0.33 \\ 0.3 & 0.4 & 0.3 \\ 0.3 & 0.3 & 0.4\end{matrix} ] \qquad ( 4 )$$

where na, rt, and cl are no-activity, rattle, and climb, respectively.

This may only be based on observations; however, the EM algorithm may be used to deduce the state transition matrix more accurately.

A sensor was installed on three different fences. One of the fences was loose, while two other were tight. The size of loose fence was 2.5×2.2 meters (width*height). The two other fences were 3×2.2 meters and 4×2.5 meters in size. On each fence, two persons were asked to climb or rattle the fence and 72 data clips were recorded.

Table I provides more details:

TABLE I
Database information

| Event | No. of | Duration of event | |
|---|---|---|---|
| Type | events | (seconds) | Test Condition |
| Activity | 2 | 420 | Motionless or windy |
| | | | condition |
| Rattling | 50 | 30 | 2 different persons |
| | | | Different position on the |
| | | | fence |
| | | | Different speed |
| Climbing | 20 | 15 | 2 different persons |
| | | | 3 time attempts |

The data was divided into two parts: training and testing. The classifiers were trained using the train data set and tested with the test data.

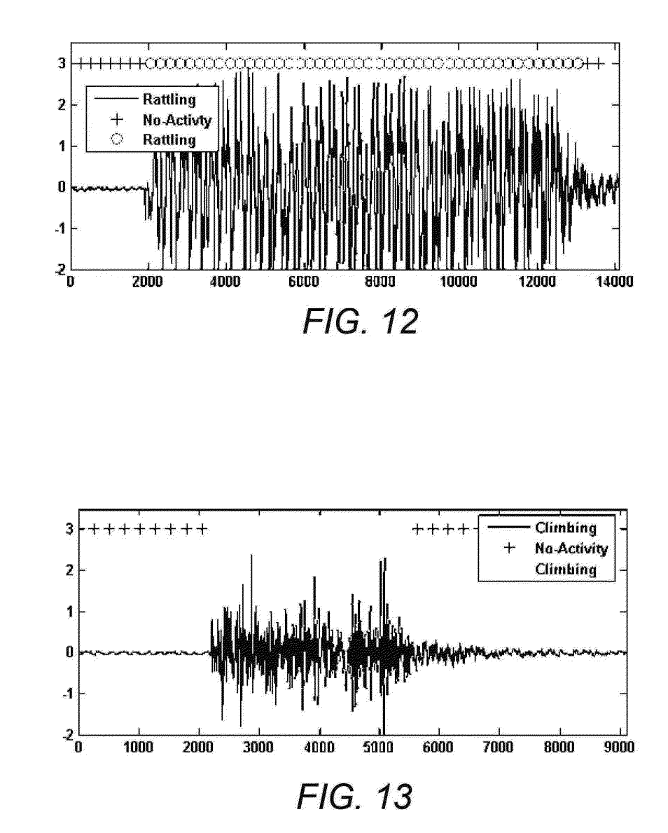

FIG. 12 illustrates an output of the classifier during rattling.

FIG. 13 illustrates an output of the classifier during climbing.

These examples illustrate that the classifier successfully discriminated rattling and climbing from background (substantially no-activity).

The classification results for test data is listed in Table II. Table II is also the confusion matrix for these classes.

TABLE II
Classification result (confusion matrix)

| | Detection Rate (%) | | |
|---|---|---|---|
| | Motionless | Rattling | Climbing |
| Motionless | 100 | 0 | 0 |
| Rattling | 0 | 90.4 | 9.6 |
| Climbing | 0 | 1.8 | 98.2 |

Table II shows that the system has more than 95 percent accuracy in the classification of events. The system's maximum false rejection rate is 5 percent and maximum false acceptance rate is 6 percent.

A review of the misclassified data shows that most of the errors occur in the transition between no-activity and event frames. Another common type of error is rattling which happens between climbing events. Indeed, a climber may only pause a few times before he/she finishes his/her climb. During each pause, the fence may rattle in its natural damping frequency (or no-activity).

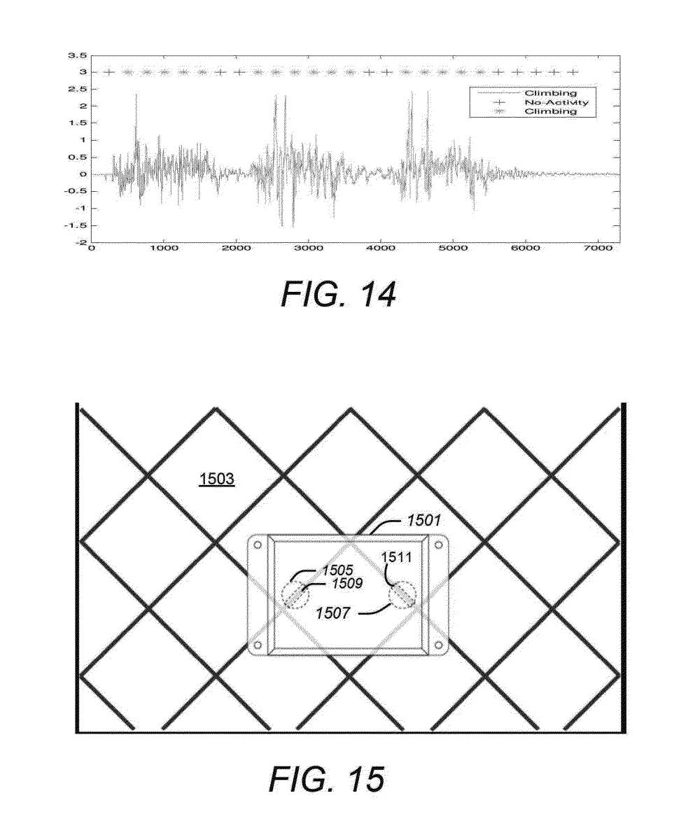

FIG. 14 illustrates detection of rattling between climbing events.

To check the fence intrusion detection system, a sensor was installed on a fence in Joshua Tree, Calif. for more than two days. The fence was monitored with a camera. The false acceptance rate for no-activity was zero during these periods. The real time test results confirmed the stability and performance of the fence intrusion detection system.

An inexpensive and compact system has now been described which may detect suspicious activities on a fence and discriminate between rattling and climbing, as well as between these and/or other types of activity. The system may be employed in windy or rainy conditions without any alteration in the algorithm. System performance may be above 90% for the data recorded from three different fences—off-line test—and a two-day—real time test—test in the Joshua Tree, Calif.

The system may be installed on fences of different sizes and shapes.

The sensor may be installed in the center of the fence such that the z-axis of accelerometer is perpendicular to the fence and the x-axis along the earth gravity direction. The algorithm may need modification if the sensor is installed at a different location on the fence.

Rattling or climbing of a fence may generate harmonics which may propagate to adjacent panels. The propagated harmonics of the adjacent panels may cause false positive recognition.

FIG. 15 illustrates a fence intrusion detection system mounted on a fence. As illustrated in FIG. 15, a fence intrusion system may include a compartment 1501 housing a sensor which is configured to generate one or more signals indicative of movement of a fence 1503, as well as one or more of the other components discussed above as part of a fence intrusion detection system. The compartment 1501 may be attached to the fence 1503 by one or more fasteners, such as by screws 1505 and 1507. Each fastener may have a slot, such as a slot 1509 and 1511, which is wider than the diameter of the wire in the fence. A wire in the fence may then be slid within each slot.

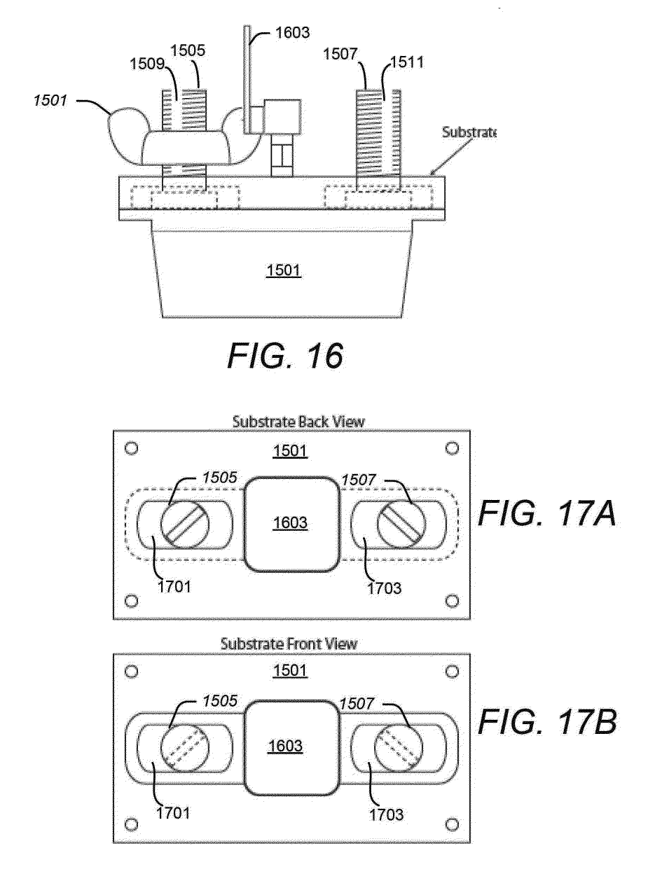

FIG. 16 illustrates a side view of a fence intrusion detection system, such as the fence intrusion detection system illustrated in FIG. 15. As illustrated in FIG. 16, a wing nut 1501 or other locking means may be used to secure screw 1505 a wire of the fence after the wire is inserted into the slot in the screw 1505. A similar wing nut or other locking means may be used to secure the wire in the fence which is slid in the other slot 1511 of the other screw 1507. An antenna 1603 may be used to wirelessly transmit a signal indicative of the discrimination determination made by the fence intrusion detection system to a remote location, such as to a central command. More or less fasteners may be used.

FIGS. 17A and 17B illustrate a front and back view, respectively, of the fence intrusion detection system illustrated in FIG. 16. As illustrated in FIGS. 17A and 17B, the compartment 1501 may be configured with one or more slots, such as slots 1701 and 1703 in which each fastener is positioned, thus enabling the longitudinal separation distance between at least two of the fasteners to be adjusted so as to enable the compartment to be attached to fences having wires with different spacings between them. Each of the fasteners and their connection to the compartment 1501 may also be configured such that the angular orientation of their slot may rotate with respect to the compartment so as to enable the compartment to be attached to fences having wires which create different mesh patterns.

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

For example, the classifier may be configured to distinguish between kicking and/or leaning, as well as or instead of climbing, rattling, and/or other types of activity. Approaches and technology the same as or different from that described above in connection with distinguishing between climbing, rattling, and/or other types of activity may be used.

Unless otherwise stated, all measurements, values, ratings, positions, magnitudes, sizes, and other specifications which are set forth in this specification, including in the claims which follow, are approximate, not exact. They are intended to have a reasonable range which is consistent with the functions to which they relate and with what is customary in the art to which they pertain.

All articles, patents, patent applications, and other publications which have been cited in this disclosure are hereby incorporated herein by reference.

The phrase “means for” when used in a claim is intended to and should be interpreted to embrace the corresponding structures and materials which have been described and their equivalents. Similarly, the phrase “step for” when used in a claim is intended to and should be interpreted to embrace the corresponding acts which have been described and their equivalents. The absence of these phrases in a claim mean that the claim is not intended to and should not be interpreted to be limited to any of the corresponding structures, materials, or acts or to their equivalents.

Nothing which has been stated or illustrated is intended or should be interpreted to cause a dedication of any component, step, feature, object, benefit, advantage, or equivalent to the public, regardless of whether it is recited in the claims.

The scope of protection is limited solely by the claims which now follow. That scope is intended and should be interpreted to be as broad as is consistent with the ordinary meaning of the language which is used in the claims when interpreted in light of this specification and the prosecution history which follows and to encompass all structural and functional equivalents.

The invention claimed is:

1. A fence intrusion detection system comprising:
a sensor configured to generate one or more signals indicative of movement of the fence; and
a signal processing system configured to distinguish based on the signals:
between movement of the fence and substantially no movement of the fence; and
between movement of the fence caused by rattling of the fence and movement of the fence caused by climbing of the fence.

2. The fence intrusion of claim 1 wherein the signal processing system is configured to distinguish base on the one or more signals between movement of the fence cause by rattling of the fence, movement of the fence caused by climbing of the fence, and movement of the fence caused by activity other than rattling or climbing of the fence.

3. The fence intrusion system of claim 1 wherein the signal processing system is configured to distinguish based on the one or more signals between movement of the fence cause by rattling of the fence, movement of the fence caused by climbing of the fence, and movement of the fence caused by kicking of the fence.

4. The fence intrusion system of claim 3 wherein the signal processing system is configured to distinguish based the on one or more signals between movement of the fence cause by rattling of the fence, movement of the fence caused by climbing of the fence, movement of the fence caused by kicking of the fence, and movement of the fence caused by activity other than rattling, climbing, or kicking of the fence.

5. The fence intrusion system of claim 1 wherein the signal processing system is configured to distinguish based on the one or more signals between movement of the fence cause by rattling of the fence, movement of the fence caused by climbing of the fence, and movement of the fence caused by leaning on the fence.

6. The fence intrusion system of claim 3 wherein the signal processing system is configured to distinguish based the on one or more signals between movement of the fence cause by rattling of the fence, movement of the fence caused by climbing of the fence, movement of the fence caused by leaning on the fence, and movement of the fence caused by activity other than rattling, climbing, or leaning on the fence.

7. The fence intrusion system of claim 1 wherein the signal processing system is configured to distinguish based on the one or more signals between movement of the fence cause by rattling of the fence, movement of the fence caused by climbing of the fence, movement of the fence caused by leaning on the fence, and movement of the fence caused by kicking of the fence.

8. The fence intrusion system of claim 3 wherein the signal processing system is configured to distinguish based the on one or more signals between movement of the fence cause by rattling of the fence, movement of the fence caused by climbing of the fence, movement of the fence caused by leaning on the fence, movement of the fence caused by kicking of the fence, and movement of the fence caused by activity other than rattling, climbing, leaning, or kicking of the fence.

9. The fence intrusion system of claim 1 wherein the fence intrusion system includes a rechargeable power source and is configured to power down a substantial portion of the signal processing system when the one or more signals from the sensor indicate that there is substantially no movement of the fence.

10. The fence intrusion system of claim 1 wherein the one or more signals from the sensor are indicative of acceleration of the fence and the signal processing system is configured to distinguish between movement and substantially no movement of the fence by comparing the magnitude of the acceleration with a threshold.

11. The fence intrusion system of claim 10 wherein threshold is dynamic and the fence intrusion system is configured to adjust the threshold.

12. The fence intrusion system of claim 11 wherein the fence intrusion system is configured to adjust the threshold based on long term changes in the magnitude of the acceleration.

13. The fence intrusion system of claim 1 wherein the signal processing system is configured to distinguish between movement and substantially no movement of the fence based on a time analysis of the one or more signals.

14. The fence intrusion system of claim 1 wherein the signal processing system:
includes a Gausian mixture model configured to detect movement of the fence from the one or more signals;
includes a Gausian mixture model configured to detect substantially no movement of the fence from the one or more signals; and
is configured to distinguish between movement and substantially no movement of the fence based on which of the Gausian mixture models provides a higher output.

15. The fence intrusion system of claim 1 wherein the signal processing system:
includes a Gausian mixture model configured to detect movement of the fence cause by rattling of the fence from the one or more signals;
includes a Gausian mixture model configured to detect movement of the fence cause by climbing of the fence from the one or more signals; and
is configured to distinguish between movement of the fence caused by rattling of the fence and by climbing of the fence based on which of the Gausian mixture models provides a higher output.

16. The fence intrusion system of claim 1 wherein the signal processing system:
includes a Gausian mixture model configured to detect movement of the fence cause by rattling of the fence from the one or more signals;
includes a Gausian mixture model configured to detect movement of the fence cause by climbing of the fence from the one or more signals;
includes a Gausian mixture model configured to detect movement of the fence cause by activity other than rattling or climbing or of the fence from the one or more signals; and
is configured to distinguish between movement of the fence caused by rattling of the fence, by climbing of the fence, and by activity other than rattling or climbing of the fence based on which of the Gausian mixture models provides a higher output.

17. The fence intrusion system of claim 1 wherein:
the sensor is configured to sense movement in three orthogonal directions X, Y, & Z; and
the signal processing system is configured to distinguish between movement of the fence caused by rattling of the fence and by climbing of the fence based on the following feature vector:
F=(Sᵥ,E_{X/z},E_{Y/Z},E_{F1|X},E_{F2|X},E_{F1|Y},E_{F2|Y},E_{F1|Z},E_{F2|Z})

18. A fence intrusion detection system comprising:
a sensor configured to generate one or more signals indicative of movement of the fence;
a signal processing system configured to distinguish based on the signals between different types of activity which cause movement of the fence; and
a wireless transmission system configured to wirelessly transmit information about the different types of activity which is distinguished by the processing system;
a rechargeable power source; and
wherein the intrusion detection system is configured to power down a substantial portion of the signal processing system when the one or more signals from the sensor indicate that there is substantially no movement of the fence.

19. A fence intrusion detection system comprising:
a sensor configured to generate one or more signals indicative of movement of the fence; and
a signal processing system configured to distinguish based on the signals between movement of the fence caused by rattling of the fence and movement of the fence caused by climbing of the fence.

20. A fence intrusion detection system comprising:
a sensor configured to generate one or more signals indicative of movement of the fence;
a compartment housing the sensor; and
at least one fastener configured to attach the compartment to a wire in the fence, the fastener having a slot which is wider than the diameter of the wire in the fence.

21. The fence intrusion detection system of claim 20 comprising a plurality of fasteners, each configured to attach the compartment to a wire in the fence, and each having a slot running fastener which is wider than the diameter of the wire in the fence.

22. The fence intrusion detection system of claim 21 wherein each of the fasteners are configured such that the angular orientation of their slot may rotate with respect to the compartment so as to enable the compartment to be attached to fences having wires which create different mesh patterns.

23. The fence intrusion detection system of claim 21 wherein the compartment is configured with at least one slot in which at least one fastener is positioned, thus enabling the longitudinal separation distance between at least two of the fasteners to be adjusted so as to enable the compartment to be attached to fences having wires with different spacings between them.
